(19) United States
(12) Patent Application Publication
(10) Pub. No.: US 2026/0252603 A1
(43) Pub. Date: Aug. 27, 2026

(54) APPARATUS AND METHOD FOR PROMPT TUNING

(71) Applicant: RESEARCH & BUSINESS FOUNDATION SUNGKYUNKWAN UNIVERSITY, Suwon-si (KR)

(72) Inventors: Sung Eun HONG, Seoul (KR); Youjia ZHANG, Seoul (KR); Huiling LIU, Seoul (KR)

(21) Appl. No.: 19/545,275

(22) Filed: Feb. 20, 2026

(30) Foreign Application Priority Data
Feb. 26, 2025 (KR) 10-2025-0025254

(51) Int. Cl. G06F 16/3329; G06F 40/284

(52) U.S. Cl. CPC G06F 16/33295; G06F 40/284

(57) ABSTRACT

The present disclosure relates to a prompt tuning apparatus and a prompt tuning method, wherein the prompt tuning apparatus may comprise a storage configured to store an image and at least one class, and a processor configured to obtain a class-agnostic attribute based on the at least one class, generate a universal attribute-based text based on the class-agnostic attribute, obtain a first token by performing tokenization on the universal attribute-based text, obtain an image embedding corresponding to the image, obtain a class prior based on the image embedding, obtain a class-prior-reflected token by mapping the class prior to the first token, and obtain a predicted average embedding for the class-prior-reflected token.

### CROSS-REFERENCE TO RELATED APPLICATION

This application claims the priority benefit of Korean Patent Application No. 10-2025-0025254 filed on Feb. 26, 2025 in the Korean Intellectual Property Office, the disclosures of which are incorporated herein by reference.

### BACKGROUND

### 1. Field

The present invention relates to a prompt tuning apparatus and a prompt tuning method.

### 2. Description of the Related Art

VLMs (Vision-Language Models) are models designed to process multimodal data formed of an image and text and learn a relationship between two data types, and can identify or predict a relationship between an image and text, and thus is used in various tasks such as text-based image search, image-based text search, or visual question response (VQA). However, retraining the vision-language model for downstream applications has a problem that requires extensive parameters. Therefore, in order to solve this problem, methodologies such as fine-tuning, prompt tuning, adaptors, and LoRA have been introduced.

The prompt tuning refers to a process of adjusting and training a prompt to achieve optimal performance in a specific task in a trained model such as a Large Language Model (LLM). Here, the prompt is input data or a query provided to the model in order to perform a specific task, and is usually provided to provide information about a context or a guideline to the model. Such prompt tuning is known to be able to adapt a language model and the like to various tasks quite effectively while minimizing parameter changes. However, prompt tuning shows limitations in adaptability to an unidentified domain due to distribution shift issues in testing. In order to solve this problem, a TPT (Test-time Prompt Tuning) method has been introduced. However, such a test time prompt tuning has a disadvantage in that it is difficult to apply it to a vision-language model because it is easy to cause alignment errors because it often overlooks visual-textual alignment by focusing only on either the visual branch or the textual branch in an unseen domain. In particular, such alignment errors may degrade the generalization performance of the prompt method. In addition, the conventional test time prompt tuning method also has a problem in that the visual diversity of the augmented view is insufficient. This lack of visual diversity has hindered the generalization of test time prompt tuning methods to the outside of the distribution, and has been a cause of hindering the effectiveness of prompt tuning in downstream operations.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

An object of the present disclosure is to provide a prompt tuning apparatus and a prompt tuning method capable of enhancing bi-modal alignment between visual and text embeddings by utilizing a class-agnostic attribute generated by a language model.

In order to solve the above problems, a prompt tuning apparatus and a prompt tuning method are provided.

A prompt tuning apparatus according to an embodiment of the present disclosure may comprise a storage configured to store an image and at least one class and a processor configured to obtain a class-agnostic attribute based on the at least one class, generate a universal attribute-based text based on the class-agnostic attribute, obtain a first token by performing tokenization on the universal attribute-based text, obtain an image embedding corresponding to the image, obtain a class prior based on the image embedding, obtain a class-prior-reflected token by mapping the class prior to the first token, and obtain a predicted average embedding for the class-prior-reflected token.

According to an embodiment, wherein the universal attribute-based text comprises a unique identifier, wherein the first token comprises a token corresponding to the unique identifier, and wherein the processor may be further configured to map the class prior to the first token by replacing the token corresponding to the unique identifier with the class prior.

According to an embodiment, wherein the processor may be further configured to obtain an augmented image by using the predicted average embedding, obtain an image embedding for the augmented image, obtain an enhanced text prompt based on the class-agnostic attribute, obtain a text embedding for the enhanced text prompt, and calculate a prediction probability by using a similarity between the image embedding for the augmented image and the text embedding for the enhanced text prompt.

According to an embodiment, wherein the processor may be further configured to derive an optimal prompt based on the prediction probability, wherein the optimal prompt is a prompt that minimizes a marginal entropy function defined based on the prediction probability.

According to an embodiment, wherein the processor may be further configured to obtain a second token used as a ground-truth embedding by performing tokenization on a prompt including a name of a class corresponding to the image.

According to an embodiment, wherein the processor may be further configured to obtain the at least one class, obtain a query for the at least one class by using a prompt template, generate a response corresponding to the query based on at least one language model, and obtain the class-agnostic attribute from the response, thereby obtaining the class-agnostic attribute based on the at least one class.

A prompt tuning method according to an embodiment of the present disclosure may comprise obtaining a class-agnostic attribute based on at least one class, generating a universal attribute-based text based on the class-agnostic attribute, obtaining a first token by performing tokenization on the universal attribute-based text, obtaining an image embedding corresponding to an image, obtaining a class prior based on the image embedding, obtaining a class-prior-reflected token by mapping the class prior to the first token and obtaining a predicted average embedding for the class-prior-reflected token.

According to an embodiment, wherein the universal attribute-based text comprises a unique identifier, wherein the first token comprises a token corresponding to the unique identifier, and wherein obtaining the class-prior-reflected token by mapping the class prior to the first token may comprise mapping the class prior to the first token by replacing the token corresponding to the unique identifier with the class prior to obtain the class-prior-reflected token.

According to an embodiment, A prompt tuning method may further comprise obtaining an augmented image by using the predicted average embedding, obtaining an image embedding for the augmented image, obtaining an enhanced text prompt based on the class-agnostic attribute and obtaining a text embedding for the enhanced text prompt, and calculating a prediction probability by using a similarity between the image embedding for the augmented image and the text embedding for the enhanced text prompt.

According to an embodiment, A prompt tuning method may further comprise deriving an optimal prompt based on the prediction probability, wherein the optimal prompt is a prompt that minimizes a marginal entropy function defined based on the prediction probability.

According to an embodiment, A prompt tuning method may further comprise obtaining a second token used as a ground-truth embedding by performing tokenization on a prompt including a name of a class corresponding to the image.

According to an embodiment, obtaining the class-agnostic attribute based on the at least one class may comprise obtaining the at least one class, obtaining a query for the at least one class by using a prompt template, generating a response corresponding to the query based on at least one language model, and obtaining the class-agnostic attribute from the response.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of a prompt tuning apparatus according to an embodiment.

FIG. 2 is a diagram for describing an operation of a general attribute generation unit according to an embodiment.

FIG. 3 is a block diagram of a text-based image enhancement unit according to an embodiment.

FIG. 4 is a block diagram of a class prior mapping unit according to an embodiment.

FIG. 5 is a flowchart of a prompt tuning method according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, as well as methods for achieving them, will become apparent by referring to the embodiments described below in conjunction with the accompanying drawings. However, the present invention is not limited to the embodiments disclosed herein and may be implemented in various different forms. The embodiments are provided merely to ensure a complete disclosure of the invention and to fully convey the scope of the invention to those skilled in the art. The present invention shall be defined solely by the scope of the claims.

Hereinafter, terms used in the present specification will be briefly described, and the present disclosure will be described in detail. Although terms used in the present disclosure are selected as general terms currently widely used in the art in consideration of functions in the present disclosure, the terms may vary according to the intention of those of ordinary skill in the art, precedents, or emergence of new technologies. In addition, in specific cases, terms may be arbitrarily selected by the applicant, and in this case, the meaning of the terms will be described in detail in the corresponding description. Accordingly, the terms used in the present disclosure should be defined based on the meanings of the terms and the overall contents of the present disclosure, rather than simple names of the terms.

Throughout the specification, when a part is referred to as being “connected” to another part, it may mean that the part and the other part are physically connected to each other and/or electrically connected to each other. In addition, when a part is referred to as “including” or “comprising” another part, it does not exclude other parts unless otherwise stated, but means that it may further include other parts depending on embodiments.

Terms such as “unit”, “module”, and the like used in the specification refer to units corresponding to all or part of at least one device, system, method, structure, and material, and may process a predetermined function or operation depending on the situation. The “unit”, “module”, and the like may be implemented as software, hardware such as a Field Programmable Gate Array (FPGA) or an Application Specific Integrated Circuit (ASIC), or a combination of software and hardware, depending on designers, administrators, or users. However, the “unit”, “module”, and the like are not limited to only software or hardware. The “unit”, “module”, and the like may be configured to reside in an addressable storage medium or configured to execute on one or more processors.

Accordingly, as an example, terms such as “unit”, “module”, and the like may include components such as software components, object-oriented software components, class components, and task components, and processes, functions, attributes, procedures, subroutines, segments of program code, drivers, firmware, microcode, circuitry, data, databases, data structures, tables, arrays, and variables. According to an embodiment, one “unit”, “module”, or the like may be implemented as a single physical or logical configuration, or may be implemented as a plurality of physical or logical configurations. In addition, a plurality of “units”, “modules”, and the like may be implemented as a single physical or logical configuration.

Expressions such as first to N-th (where N is a natural number of 1 or more) are used to distinguish at least one part(s) from other part(s) for convenience of description, and may be arbitrarily selected and added to components. For example, a component named as a first component may be differently named as a second component, and a component named as a second component may also be differently named as a first component. In addition, expressions such as first to N-th do not necessarily mean that these components are sequential unless otherwise stated.

The term “and/or” may include a combination of a plurality of related items or any one of a plurality of related items, but does not exclude a combination of two or more of the plurality of related items. Singular expressions may include plural expressions unless the context clearly indicates otherwise. In addition, generally, an underscore (_) indicates that a character added after the underscore is a subscript of a character located before the underscore, and a caret (\hat{ }) indicates that a character added after the caret is a superscript of a character located before the caret, but they may be used in different meanings depending on situations.

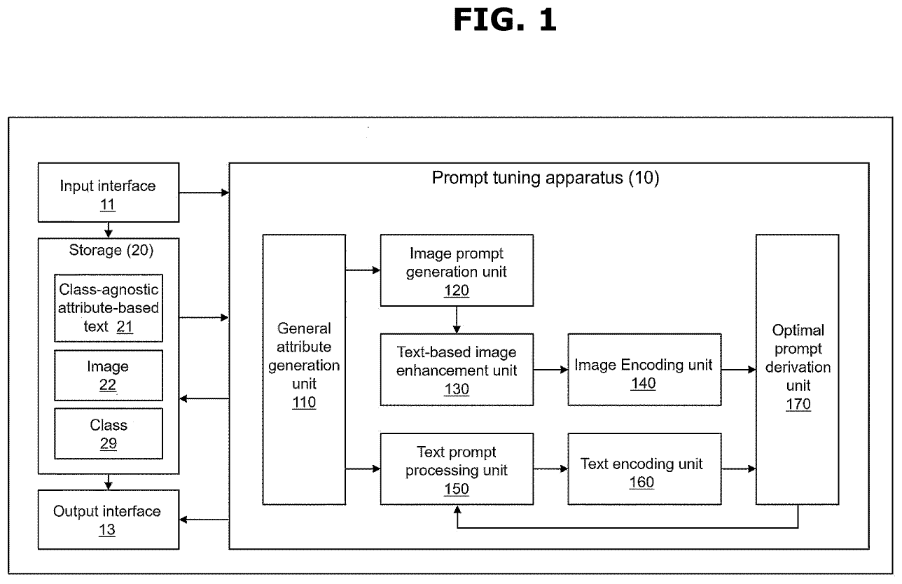

Hereinafter, an embodiment of a prompt tuning apparatus will be described with reference to FIGS. 1 to 4.

FIG. 1 is a block diagram of a prompt tuning apparatus according to an embodiment.

Referring to FIG. 1, the prompt tuning apparatus 10 may include an input interface 11, an output interface 13, a storage 20, and a processor 100. If necessary, at least one of the input interface 11, the output interface 13, and the storage 20 may be omitted. At least two of the input interface 11, the output interface 13, the storage 20, and the processor 100 may be provided to transmit data, commands, instructions, and the like through a circuit line, a cable, and/or a wireless communication network, either in one or both directions.

The input interface 11 may receive data necessary for the operation of the prompt tuning apparatus 10. For example, the input interface 11 may receive at least one image 22 to be used for testing, training, or prediction, or at least one class 29 to be used for classification of the image 22. In addition, the input interface 11 may receive a text to be used as a query or prompt. In addition, the input interface 11 may be provided to receive a program provided to perform an operation of the prompt tuning apparatus 10 or a user's command regarding an operation of the prompt tuning apparatus 10. The input interface 11 may be implemented using, for example, a keyboard, a mouse, a tablet, a touch screen, a touch pad, a scanner device, an image capturing module, a pressure sensor, a proximity sensor, a microphone, a data input/output terminal, or a communication module (e.g., a LAN card, a short-range communication module, or a mobile communication module), but is not limited thereto.

The storage 20 may temporarily or non-temporarily store data or programs required for the operation of the prompt tuning apparatus 10. For example, the storage 20 may store one or more universal attribute-based text 21 generated by a general attribute generation unit 110 and input to a text prompt generation unit 150, or may store one or more images 22 to be input to an image prompt generation unit 120. In addition, the storage 20 may store one or more classes 29 used for generation of general attributes, and the class(es) 29 may be stored, for example, in the form of a list. According to an embodiment, the storage 20 may be implemented using at least one of a register, a cache memory, a main memory, and an auxiliary memory. These components may be implemented using a semiconductor device, a magnetic disk, or the like.

The output interface 13 may output data 21, 22, 31 stored in the storage 20 or processing results of the processor 100, for example, a prompt tuning result (i.e., optimized prompt(s)), to the outside. Such data may be output visually or audibly and provided to a user. In addition, such data (e.g., the tuned prompt(s)) may be transmitted to another information processing apparatus in which a large language model or a vision-language model is implemented. The output interface 13 may include, for example, a display, a printer device, a speaker device, a video output port, a data input/output port, or a communication module, but is not limited thereto.

The processor 100 may perform arithmetic processing for prompt tuning and, based thereon, may obtain a prompt tuning result, for example, an optimized prompt. In this case, the processor 100 may perform a prompt tuning operation by executing a program stored in the storage 20 and performing all or part of operations to be described below one or more times. The processor 100 may be implemented based on, for example, at least one electronic device capable of performing various types of computation and control processing, such as a central processing unit (CPU), a graphics processing unit (GPU), a neural processing unit (NPU), a microcontroller unit (MCU), an electronic control unit (ECU), an application processor (AP), a microprocessor (Micom), and/or the like. According to an embodiment, the processor 100 may be implemented using two or more homogeneous processing devices (e.g., two or more CPUs) or using two or more heterogeneous processing devices (e.g., a CPU and a GPU).

According to an embodiment, as illustrated in FIG. 1, the processor 100 may include a general attribute generation unit 110, an image prompt generation unit 120, a text-based image enhancement unit 130, an image encoding unit 140, a text prompt processing unit 150, a text encoding unit 160, and an optimal prompt derivation unit 170. As necessary, at least one of the general attribute generation unit 110, the image prompt generation unit 120, the text-based image enhancement unit 130, the image encoding unit 140, the text prompt processing unit 150, the text encoding unit 160, and the optimal prompt derivation unit 170 may be omitted.

The general attribute generation unit 110 may receive a class 29 and, based thereon, may obtain at least one class-agnostic attribute.

Here, the class 29 may refer to a specific category or label to which predetermined data belongs. For example, the class may include an object such as a cat, a chicken, a pug, or a car. The class 29 may be predefined by a user or a designer in advance or afterward, or may be obtained by the processor 100 during a processing procedure. According to an embodiment, a plurality of classes 29 may be provided, and in this case, the classes 29 may be stored in the storage 20 in the form of a list as described above.

A class-agnostic attribute refers to an attribute that is applicable to at least one sample (e.g., an image 22) and can be universally or generally applied regardless of a class 29 to which the sample(s) belong. When learning the image 22, the class-agnostic attribute may include universal attributes related to the image 22, such as color, surrounding environment (background), and/or style (e.g., visual effects). However, the class-agnostic attribute is not limited thereto. According to an embodiment, the class-agnostic attribute may be predefined by a user or a designer in advance or afterward, or may be obtained by the processor 100 during a processing procedure.

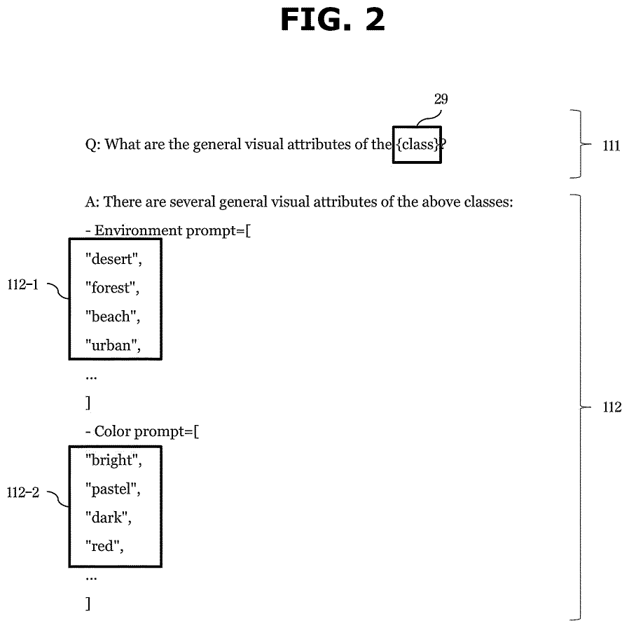

FIG. 2 is a diagram for describing an operation of a general attribute generation unit according to an embodiment.

According to an embodiment, as illustrated in FIG. 2, the general attribute generation unit 110 may generate class-agnostic attributes (112-1, 112-2, etc.) corresponding to at least one class 29 by using a predetermined prompt template. Here, the prompt template may be provided to include a format, a pattern, a form, or a sentence structure for a query 111 and a response 112. For example, the general attribute generation unit 110 may obtain one or more classes 29 and generate a query 111 for the one or more classes 29 by using the prompt template (e.g., “What are the general visual attributes of the {class}?”). In addition, the general attribute generation unit 110 may input the query 111 to a language model and generate a response 112 corresponding to the query 111 (e.g., “There are several general visual attributes of the above classes: Environment prompt=[‘desert’, . . . ], Color prompt=[‘bright’, . . . ] . . . ”) in conformity with the prompt template. Here, the response 112 includes class-agnostic attributes (112-1, 112-2, etc.). In other words, the class-agnostic attributes (112-1, 112-2, etc.) are extracted from the response 112 and obtained. The one or more class-agnostic attributes (112-1, 112-2, etc.) output through the response 112 may be transmitted to at least one of the image prompt generation unit 120 and the text prompt processing unit 150. The above-described prompt template may be defined by a user or a designer according to an embodiment, or may be selected and determined by the processor 100.

According to an embodiment, the general attribute generation unit 110 may be implemented by using a predetermined language model. Here, the predetermined language model may include, for example, GPT (Generative Pre-trained Transformer), BERT (Bidirectional Encoder Representations from Transformers), ROBERTa, ViT (Vision Transformer), a memory network (Memory Network), or Turing-NLG (Turing Natural Language Generation), but is not limited thereto. In addition, according to an embodiment, the language model may be implemented based on a convolutional neural network (CNN) or a long short-term memory (LSTM) network.

The image prompt generation unit 120 may receive class-agnostic attributes (112-1, 112-2, etc.) from the general attribute generation unit 110, and may obtain input data for the text-based image enhancement unit 130 based on the class-agnostic attributes 112-1, 112-2.

Input data for the text-based image enhancement unit 130 may be generated in a text form, and may be generated to include class-agnostic attributes 112-1, 112-2. Hereinafter, the generated input data is referred to as a universal attribute-based text 21. Specifically, the image prompt generation unit 120 may generate the universal attribute-based text 21 by combining class-agnostic attributes 112-1, 112-2 with given descriptive text. Here, the descriptive text may include at least one of a prompt prefix (t, e.g., t=“a photo of”), a learnable prompt (t={p_1, p_2, . . . , p_M}), and a suffix (e.g., “which (is/has/etc.)”). In this case, the image prompt generation unit 120 may generate the universal attribute-based text 21 by combining, for example, the prompt prefix (t, e.g., t=“a photo of”) or the learnable prompt (t={p₁, p₂, . . . , p_M}) with attributes of the obtained class 29, and may generate the universal attribute-based text 21 by combining attributes of the class 29 before or after the suffix (e.g., “which (is/has/etc.)”). In addition, the image prompt generation unit 120 may further combine a unique identifier to generate the universal attribute-based text 21. Here, the unique identifier may be a token corresponding to an object identified or classified from the input image 22, and may be represented, for example, by an asterisk (*). The unique identifier may be combined, for example, before or after the prompt prefix (t, e.g., t=“a photo of”) or the learnable prompt (t={p₁, p₂, . . . , p_M}). Accordingly, in an example, the universal attribute-based text 21 may be provided in the form of “a photo of which (is/has/etc.) {attr}”, where {attr} denotes the class-agnostic attributes 112-1, 112-2. The generated universal attribute-based text 21 may be transmitted to the text-based image enhancement unit 130.

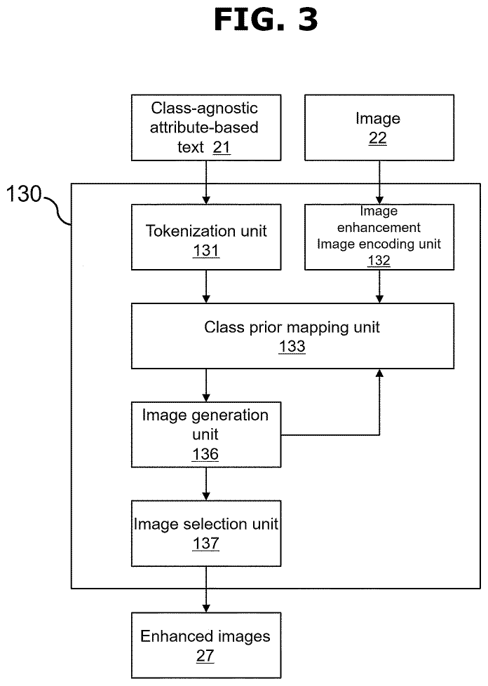

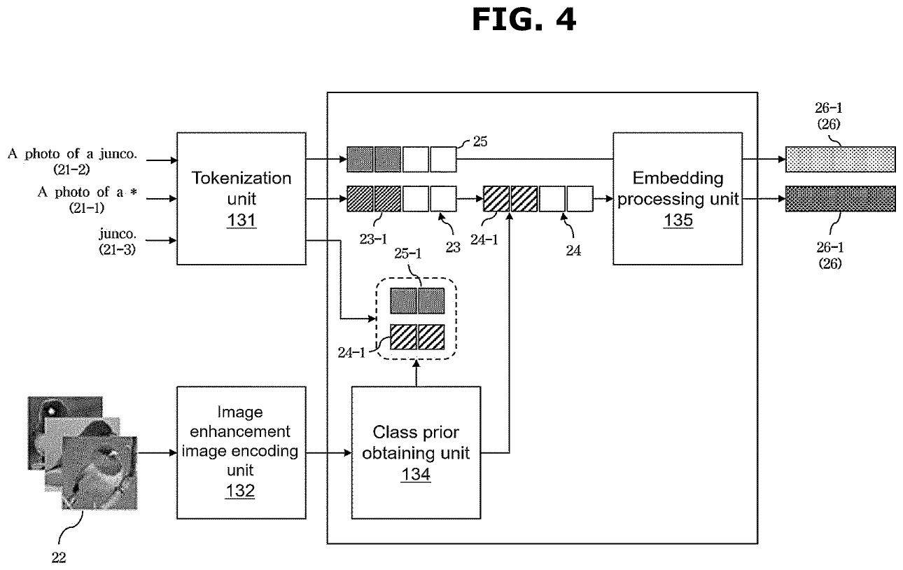

FIG. 3 is a block diagram of a text-based image enhancement unit according to an embodiment, and FIG. 4 is a block diagram of a class prior mapping unit according to an embodiment.

As illustrated in FIG. 3, the text-based image enhancement unit 130 may receive at least one universal attribute-based text 21 and at least one image 22, and may generate one or more augmented images 27 corresponding to the at least one image 22 by using the universal attribute-based text 21 and the image 22. The augmented image 27 may be referred to as a view image depending on circumstances. Accordingly, diversity within a class 29 may be augmented.

According to an embodiment, the text-based image enhancement unit 130 may include a tokenization unit 131, an image enhancement Image encoding unit 132, a class prior mapping unit 133, an image generation unit 136, and an image selection unit 137.

Referring to FIGS. 3 and 4, the tokenization unit 131 may obtain a universal attribute-based text 21 and may obtain at least one token 23, 25 by separating the universal attribute-based text 21 into one or more tokens (i.e., by performing tokenization). For example, when input image(s) 22 correspond to an image related to a specific object (e.g., a junco) (which may be an image without an assigned label), the tokenization unit 131 may perform tokenization on an attribute-based prompt 21-1 (e.g., the universal attribute-based text 21) including a unique identifier (*) instead of a name of a class 29, thereby obtaining at least one first token 23 corresponding thereto. In addition, and/or alternatively, the tokenization unit 131 may perform tokenization on a prompt 21-2 including a name of the class 29 corresponding to the input image(s) 22 (e.g., junco), thereby obtaining at least one second token 25 corresponding to the prompt 21-2. Here, the first token 23 may include a token 23-1 corresponding to the unique identifier (*), and may be used to obtain a predicted average embedding 26-1. The second token 25 may be used to obtain a ground-truth embedding 26-2, and according to an embodiment, may be generated or used only during a training process. The second token 25 may include a token 25-1 corresponding to an actual class name. Depending on circumstances, the tokenization unit 131 may further receive a class name 21-3 of the class 29 and may additionally obtain a third token 25-1 corresponding to the class name 21-3. The one or more tokens 23, 25, 25-1 obtained as described above are transmitted to the class prior mapping unit 133.

The image enhancement image encoding unit 132 may receive an image 22 and may generate an image embedding corresponding to the image 22 by mapping the image 22 into a vector space using a predetermined encoder. The image embedding may be represented in a vector form and may be provided to include characteristics of the image 22 (e.g., patterns or attribute information). The image embedding may be transmitted to the class prior mapping unit 133.

The class prior mapping unit 133 may obtain a token 23 and an image embedding, and may obtain a token 24 in which a predicted class prior (class prior, also referred to as class priority, class prior probability, or the like) 24-1 is reflected (hereinafter, referred to as a class-prior-reflected token), based on the image embedding. Here, the class prior may refer to a probability that each predetermined class appears in a given dataset (e.g., image(s) 22).

Specifically, referring to FIG. 3, the class prior mapping unit 133 may include a class prior acquisition unit 134, and the class prior acquisition unit 134 may receive one or more image embeddings corresponding to the image 22 from the image enhancement image encoding unit 132 and may extract and obtain a class prior 24-1 from the one or more image embeddings. Here, the class prior 24-1 may include a latent class prior. The class prior 24-1 is a value representing unique attributes or characteristics of each class 29 in a latent space, and may reflect uniqueness of each class 29. The class prior 24-1 is mapped to the first token 23, thereby obtaining a class-prior-reflected token 24. In this case, mapping of the class prior 24-1 may be performed, for example, by replacing at least one token 23-1 corresponding to a unique identifier (*) among the first token 23 with the obtained class prior 24-1. The obtained class-prior-reflected token 24 is transmitted to an embedding processing unit 135 of the class prior mapping unit 133.

The embedding processing unit 135 may receive at least one token 24, 25 and may output at least one text embedding 26 corresponding to the at least one token 24, 25. For example, the embedding processing unit 135 may obtain a class-prior-reflected token 24 and may obtain one or more text embeddings corresponding to the class-prior-reflected token 24, that is, predicted average embedding 26-1. Here, the obtained predicted average embedding 26-1 may be a text embedding having category consistency. In addition, the embedding processing unit 135 may further obtain one or more text embeddings corresponding to the second token 25, that is, ground-truth embeddings 26-2, by using the second token 25. According to an embodiment, the obtained predicted average embedding 26-1 may be aligned together with the ground-truth embedding 26-2 by using a SimCLR contrastive loss. The generated text embedding 26, for example, the predicted average embedding 26-1, may be transmitted to the image generation unit 136, as illustrated in FIG. 3.

The class prior mapping unit 133 may be optimized by using a loss function L as described in Equation 1 below.

$$L = {\sum }_{i = 1}^{C} {l}_{i} \qquad [ Equation 1 ]$$

Here, C denotes the number of classes. I_i denotes a class-prior preservation loss (CP loss) for an i-th class (category), and may be defined as shown in Equation 2 below.

$${l}_{i} = - log ( \frac{exp ( sim ( {e}_{i} , {\hat{e}}_{i} ) )}{{\sum }_{j = 1}^{C} I [ j \neq i ] exp ( sim ( {e}_{i} , {\hat{e}}_{j} ) )} ) + λ {‖ η ( {y}_{i} ) - ω ( {v}_{i} ) ‖}^{2} \qquad [ Equation 2 ]$$

In Equation 2, \hat{ }e_i denotes a predicted average embedding 26-1, and e_i denotes a ground-truth embedding 26-2. The predicted average embedding \hat{ }e_i and the ground-truth embedding e_i may be obtained according to processing results of the embedding processing unit 135, as described above. Sim( ) denotes a predetermined similarity function, which may be defined according to a selection of a user or a designer. For example, Sim( ) may include a cosine similarity function. η(y_i) and ω(v_i) denote a predicted class prior 24-1 and an actually labeled token 25-1 (which may be in the form of an embedding vector), respectively. Here, the actually labeled token 25-1 may include a token corresponding to a name of the class 29 within the second token 25. A is a parameter for balancing an embedding-level contrastive loss (a first term on a right-hand side of Equation 2) and a token-level regularization loss (a second term on the right-hand side of Equation 2). As described above, since the class prior mapping unit 133 is trained using a contrastive learning scheme, the prompt tuning apparatus 10 can be directly applied to unseen new categories and/or domains without fine-tuning.

The image generation unit 136 may restore and generate one or more images having intra-class diversity by augmenting images using a text embedding 26 having category consistency, for example, the predicted average embedding 26-1. According to an embodiment, the image generation unit 136 may restore an image corresponding to the predicted average embedding 26-1 by using a predetermined diffusion model, for example, a frozen diffusion model. Here, the diffusion model may include, for example, Stable Diffusion or DALL⋅E, but is not limited thereto. As a result, K augmented images 27 having intra-class diversity, for example, augmented views, are generated. This may be expressed by Equation 3 below.

$${𝒟}_{k} ( {x}_{test} ) = 𝒢 ( {e}_{ω} , {n}_{k} ) \qquad [ Equation 3 ]$$

Here, D_k( ) denotes a k-th generated augmentation (k is a natural number greater than or equal to 1), and e_ω denotes the predicted average embedding 26-1. n_k denotes sampled noise for generating the k-th augmentation, and may follow a normal distribution having a mean of 0 and a variance of 1 (n~N(0,1)). G( ) denotes a diffusion model.

The image selection unit 137 may select an appropriate image from a plurality of generated images. For example, the image selection unit 137 may select and obtain K augmented images by using at least one of entropy-based selection and similarity-based selection. The entropy-based selection may be performed, for example, by selecting cases in which an entropy operation result (H(p_k)) of an output probability distribution (p_k) is smaller than a predetermined threshold value. The similarity-based selection may be performed based on, for example, cosine similarity. Accordingly, among the augmented images generated by the image generation unit 136, images having ambiguous relevance or images generated erroneously may be removed. The augmented images 27 are transmitted to an image encoding unit 140, as illustrated in FIG. 1.

The image encoding unit 140 may perform encoding on the augmented image 27 to obtain an image embedding corresponding to the augmented image 27. In addition, the image encoding unit 140 may perform encoding on an original image 22 to obtain an image embedding corresponding to the original image 22. An image embedding for at least one of the original image 22 and the augmented image 27 is transmitted to the optimal prompt derivation unit 170.

As described above, the text-based image enhancement unit 130 replaces a token 23-1 of a unique identifier (*) with a class prior 24-1 instead of a name of a class 29 in a text space, thereby enabling the embedding processing unit 135 to generate a text embedding 26-1 having category consistency. As the text embedding can be provided to include universal attributes in this manner, intra-class diversity is enhanced. In addition, text-driven visual augmentations can be derived from text without using the name of the class 29. As a result, it is possible to address conventional problems of overfitting and limited intra-class diversity.

The text prompt processing unit 150 may receive one or more class-agnostic attributes (112-1, 112-2, etc.) from the general attribute generation unit 110, and may enhance a text prompt by combining the one or more class-agnostic attributes (112-1, 112-2, etc.) with at least one of a prompt and a class 29 to obtain an enhanced text prompt. In this case, the text prompt processing unit 150 may generate text to be input for each category by adding at least one class 29 to at least one prompt prefix (which may be learnable) that is predefined by a user or a designer or set to be learnable, and further adding at least one class-agnostic attribute (112-1, 112-2, etc). thereto. Here, the prompt prefix may include an attribute-based descriptor set (D_c) That is, each class c may be associated with an attribute-based descriptor set (D_c). For example, each class 29 may be associated with a phrase for description (e.g., “which (is/has/etc.) {att.}”) through an operation of the text prompt processing unit 150. If the class 29 is a cat and an attribute delivered from the general attribute generation unit 110 is a style, input text may be generated in a form of “cat, which is cartoon style”. According to an embodiment, the text prompt processing unit 150 may perform prompt optimization by converting class-embedding retrieval into a dictionary-based approach with respect to a given target category (C) and a query image (x). The enhanced text prompt may be transmitted to the text encoding unit 160.

The text encoding unit 160 may obtain one or more text embeddings corresponding to the enhanced text prompt and may transmit the obtained text embeddings to the optimal prompt derivation unit 170.

The optimal prompt derivation unit 170 may calculate a prediction probability for an image based on a similarity between an image embedding transmitted from the image encoding unit 140 and a text embedding transmitted from the text encoding unit 160, and may derive and obtain an optimal prompt by using the calculated prediction probability. In test-time prompt tuning (TPT), since only test samples and a class list are available in a downstream task, the optimal prompt derivation unit 170, according to an embodiment, may optimize a text prompt through a self-entropy loss based on an image 22 (e.g., a test sample image) and a total of K augmented images (views).

When an attribute-based descriptor set (D_c) for a class (c) is given, an average prediction probability therefor may be given as shown in Equation 4 below.

$$p ( c \vert x ) = \frac{1}{\vert 𝔻 c \vert} {\sum }_{d ∈ {𝔻}_{c}} p ( d \vert x ) \qquad [ Equation 4 ]$$

In Equation 4, p(c|x) on a left-hand side denotes an average prediction probability, c denotes a class, and x denotes an image 22, for example, a test image. On a right-hand side, d denotes a descriptor belonging to an attribute-based descriptor set (D_c)(d∈D₍c₎. Meanwhile, P(d|x) on the right-hand side denotes a prediction probability for the image (x), which may be determined based on Equation 5 below.

$$p ( {y}_{i} \vert {x}_{i} ) = \frac{exp ( sim ( v , {e}_{i} ) / τ )}{{\sum }_{i = 1}^{C} exp ( sim ( v , {e}_{i} ) / τ )} . \qquad [ Equation 5 ]$$

$$p ( {y}_{i} \vert {x}_{i} ) = \frac{exp ( sim ( v , {e}_{i} ) / τ )}{{\sum }_{i = 1}^{C} exp ( sim ( v , {e}_{i} ) / τ )} .$$

In Equation 5, x_i denotes an i-th input sample, and y denotes a label of a corresponding class in a C-class classification problem (y∈{y_1, y_2, . . . , y_C}). sim( ) denotes a similarity function, which may be, for example, a cosine similarity. v denotes an image embedding, and e_i denotes a text embedding. τ denotes a learnable temperature parameter of a softmax function.

According to an embodiment, the optimal prompt derivation unit 170 may perform optimization of a prompt (t) by minimizing a marginal entropy function (H(~p_t)) for randomly augmented images (i.e., images output from the text-based image enhancement unit 130). In this case, an optimized prompt (t\hat{ }*) may be calculated through Equation 6 below.

$${t}^{*} = arg {min}_{t} - {\sum }_{i = 1}^{C} \tilde{{p}_{t}} ( {y}_{i} \vert {x}_{test} ) log ( \tilde{{p}_{t}} ( {y}_{i} \vert {x}_{test} ) \qquad [ Equation 6 ]$$

In Equation 6, t\hat{ }* denotes an optimized prompt. yᵢ denotes a label of an i-th class, and x_test denotes a test image 22. ~p_t( ) denotes a prediction probability for a given test image (x_test), and may be defined as shown in Equation 7 below.

$$\tilde{{p}_{t}} = \frac{1}{{ρ}_{H} {ρ}_{C} K} {\sum }_{k = 1}^{K} 𝕀 [ {H}_{k} ] 𝕀 [ {ℳ}_{k} ] {p}_{k} ( y \vert {𝒟}_{k} ( {x}_{test} ) ) . \qquad [ Equation 7 ]$$

In Equation 7, p_H and p_C denote selection ratios. The selection ratios may be defined by a user or a designer, or may be determined by the processor 100. H_K denotes an entropy function. M_k may be a similarity-based function given by Equation 8 below. p_k in Equation 7 represents p_k on the left-hand side of Equation 4.

$${ℳ}_{k} = cos ( f ( {𝒟}_{k} ( {x}_{test} ) ) , f ( {x}_{test} ) ) > ε ) \qquad [ Equation 8 ]$$

In Equation 8, f( ) denotes an embedding function. Meanwhile, in Equations 7 and 8, D_k(x_test) denotes a k-th augmented image with respect to the test image.

Referring to Equation 6, a right-hand side of argmin corresponds to a marginal entropy based on an output probability distribution of the prediction probability (~p_t( ). Accordingly, Equation 6 derives a value (t\hat{ }*) of the prompt t that minimizes the marginal entropy function (H(~p_t)). Through such a process, the processor 100 performs optimization of the prompt, that is, prompt tuning.

The above-described prompt tuning apparatus 10 may be used by the processor 100 to train the trained model and/or may be used to generate an optimized prompt corresponding to the given image 22.

The above-described prompt tuning apparatus 10, for example, generates a class-agnostic attribute through the general attribute generation unit 110 and performs prompt tuning based on the class-agnostic attribute, thereby enhancing both the text area and the visual area in a trained model such as a large language model. In particular, this not only effectively connects the distribution gap, but also allows the trained model to show robust performance even in domains that have not been seen in advance.

In addition, the prompt tuning apparatus 10 may learn semantic class priors 24-1 from a visual space to a text space by using, for example, the text-based image enhancement unit 130, thereby promoting performance enhancement of various models based on text without fine tuning.

The tuned prompt according to the operation of the processor 100 described above is provided as an input to a predetermined learning model such as a large language model or a vision-language model, so that an output may be generated in a more precise and consistent form in a specific task. Accordingly, a predetermined learning model may be optimized in performance to suit a task, or an output may be adjusted according to a user's requirement to improve a user experience and reduce malfunction. According to an embodiment, the predetermined learning model may be provided in the prompt tuning apparatus 10 described above. In other words, the prompt tuning apparatus 10 may be implemented as, for example, a training apparatus provided to perform training of a trained model or prediction based thereon. In this case, the result of the prompt tuning is input to the above learning model according to a user's manipulation or a predefined setting, and the trained model performs training or prediction using the tuned prompt. In addition, according to another embodiment, the predetermined learning model may be provided in at least one other device physically separated from the prompt tuning apparatus 10. Here, the at least one other device may include an information processing device that is communicatively connected to the prompt tuning apparatus 10 through a wired/wireless communication network, receives a result of the prompt tuning from the prompt tuning apparatus 10, and operates based on the result. In other words, it is also possible to perform the tuning of the prompt and the processing of the trained model separately by separate devices. The predetermined learning model described above may include, for example, a transformer, a vision transformer (ViT), a DNN (Deep Neural Network), a CNN (Convolutional Neural Network), a RNN (Recurrent Neural Network), a CRNN (Convolutional Recurrent Neural Network), a DBN (Deep Belief Network), a deep Q-network, a LSTM (Long short term memory), a multi-layer perceptron, a SVM (support vector machine), a GAN (Generative Adversarial Network), a conditional generative adversarial network (cGAN, Conditional GAN), or a trained model obtained by transforming based on these learning models, but is not limited thereto.

The prompt tuning apparatus 10 may be implemented by using an apparatus specially designed to perform the above-described processing, and/or may be implemented by using at least one information processing apparatus alone or in combination. Here, the at least one information processing device may include, for example, a desktop computer, a laptop computer, a hardware device for a server, a smart phone, a tablet PC, a smart watch, a smart tag, a portable game console, a navigation device, a scanner device, a remote control device (remote controller), a digital television, a set top box, a digital media player device, a sound reproducing device (artificial intelligence speaker, etc.), a home appliance (e.g., a refrigerator, a fan, an air conditioner, or a washing machine), a manned or unmanned moving object (e.g., a vehicle, a mobile robot, a wireless model vehicle, or a robot cleaner), a manned or unmanned aerial vehicle (e.g., an aircraft, a helicopter, a drone, a model airplane, or a model helicopter), a medical device, a home/industrial/military robot or an industrial/military machine or the like, but is not limited thereto. A designer, a user, or the like may employ at least one of various devices for processing and controlling information in addition to the above-described information processing device according to a situation or condition by considering the above-described prompt tuning apparatus 10.

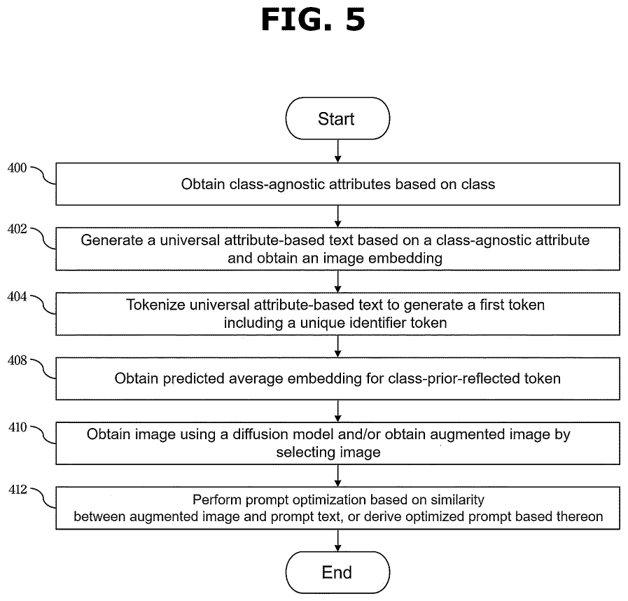

Hereinafter, an embodiment of a prompt tuning method will be described with reference to FIG. 5.

Referring to FIG. 5, a class-agnostic attribute may be obtained based on at least one class (400). The class-agnostic attribute may include an attribute that is universally or generally applicable to at least one sample regardless of a class corresponding to the at least one sample. Specifically, a query corresponding to at least one class may be generated by using a prompt template, and a response to the query may be generated through a predetermined language model. Here, the response to the query is generated to include the class-agnostic attribute. Accordingly, the class-agnostic attribute may be derived and obtained from the response.

A universal attribute-based text is generated based on the class-agnostic attribute, and simultaneously or sequentially, an embedding for a given image (e.g., a test image) may be obtained (402). The universal attribute-based text may be generated by combining the class-agnostic attribute with descriptive text. Here, the descriptive text may include at least one of a prompt prefix, a learnable prompt, additional text, and a unique identifier. In this case, the universal attribute-based text may be generated by adding the unique identifier to a suffix of the prompt prefix or the learnable prompt.

The universal attribute-based text is tokenized, and accordingly, a first token including a token corresponding to a unique identifier may be generated (404). During training, tokenization may be additionally performed on a prompt obtained by replacing the unique identifier with a name of a class corresponding to an image, thereby generating a second token. If necessary, a third token corresponding to the name of the class may be additionally obtained.

In addition, simultaneously with or sequentially with the tokenization described above, at least one image is encoded, and accordingly, at least one image embedding corresponding to the image is obtained. A class prior is obtained based on the image embedding, and the obtained class prior is mapped to the obtained first token. In this case, a token corresponding to the unique identifier within the first token is replaced with the class prior. Accordingly, a class-prior-reflected token is obtained from the first token.

A predicted average embedding is obtained for the class-prior-reflected token by using a predetermined encoder (408). During training of the model, a text embedding corresponding to the second token, that is, a ground-truth embedding, may be additionally obtained. The obtained predicted average embedding may be aligned together with the ground-truth embedding by using a SimCLR contrastive loss.

An augmented image may be obtained by using the predicted average embedding (410). The augmented image may be obtained by inputting the predicted average embedding to a diffusion model. If necessary, obtaining the augmented image may further include a process of selecting an appropriate image from a plurality of images output from the diffusion model. In this case, selection of the appropriate image from the plurality of images may be performed based on at least one of entropy-based selection and similarity-based selection. The augmented image is encoded, and accordingly, an image embedding corresponding to the augmented image is obtained.

Meanwhile, simultaneously with, prior to, or subsequent to at least one of the above-described processes (400 to 412), an enhanced text prompt may be obtained, and a text embedding corresponding to the enhanced text prompt may be obtained. An optimized prompt is derived (412) by using the text embedding corresponding to the enhanced text prompt and the image embedding corresponding to the augmented image obtained by using the predicted average embedding. Specifically, the optimal prompt may be obtained based on a similarity between the text embedding corresponding to the enhanced text prompt and the image embedding for the augmented image. In this case, the model may be trained to minimize a marginal entropy function for randomly augmented images in order to obtain the optimal prompt, and/or may output the optimal prompt through minimization of the marginal entropy function. Accordingly, optimization of the prompt is performed.

What is claimed is:

1. A prompt tuning apparatus comprising:
a storage configured to store an image and at least one class; and
a processor configured to obtain a class-agnostic attribute based on the at least one class, generate a universal attribute-based text based on the class-agnostic attribute, obtain a first token by performing tokenization on the universal attribute-based text, obtain an image embedding corresponding to the image, obtain a class prior based on the image embedding, obtain a class-prior-reflected token by mapping the class prior to the first token, and obtain a predicted average embedding for the class-prior-reflected token.

2. The prompt tuning apparatus of claim 1,
wherein the universal attribute-based text comprises a unique identifier,
wherein the first token comprises a token corresponding to the unique identifier, and
wherein the processor is further configured to map the class prior to the first token by replacing the token corresponding to the unique identifier with the class prior.

3. The prompt tuning apparatus of claim 1,
wherein the processor is further configured to obtain an augmented image by using the predicted average embedding, obtain an image embedding for the augmented image,
obtain an enhanced text prompt based on the class-agnostic attribute, obtain a text embedding for the enhanced text prompt, and
calculate a prediction probability by using a similarity between the image embedding for the augmented image and the text embedding for the enhanced text prompt.

4. The prompt tuning apparatus of claim 3,
wherein the processor is further configured to derive an optimal prompt based on the prediction probability, wherein the optimal prompt is a prompt that minimizes a marginal entropy function defined based on the prediction probability.

5. The prompt tuning apparatus of claim 1,
wherein the processor is further configured to obtain a second token used as a ground-truth embedding by performing tokenization on a prompt including a name of a class corresponding to the image.

6. The prompt tuning apparatus of claim 1,
wherein the processor is further configured to obtain the at least one class, obtain a query for the at least one class by using a prompt template, generate a response corresponding to the query based on at least one language model, and obtain the class-agnostic attribute from the response, thereby obtaining the class-agnostic attribute based on the at least one class.

7. A prompt tuning method comprising:
obtaining a class-agnostic attribute based on at least one class;
generating a universal attribute-based text based on the class-agnostic attribute;
obtaining a first token by performing tokenization on the universal attribute-based text;
obtaining an image embedding corresponding to an image;
obtaining a class prior based on the image embedding;
obtaining a class-prior-reflected token by mapping the class prior to the first token; and
obtaining a predicted average embedding for the class-prior-reflected token.

8. The prompt tuning method of claim 7,
wherein the universal attribute-based text comprises a unique identifier,
wherein the first token comprises a token corresponding to the unique identifier, and
wherein obtaining the class-prior-reflected token by mapping the class prior to the first token comprising:
mapping the class prior to the first token by replacing the token corresponding to the unique identifier with the class prior to obtain the class-prior-reflected token.

9. The prompt tuning method of claim 7, further comprising:
obtaining an augmented image by using the predicted average embedding, obtaining an image embedding for the augmented image;
obtaining an enhanced text prompt based on the class-agnostic attribute and obtaining a text embedding for the enhanced text prompt; and
calculating a prediction probability by using a similarity between the image embedding for the augmented image and the text embedding for the enhanced text prompt.

10. The prompt tuning method of claim 9, further comprising:
deriving an optimal prompt based on the prediction probability,
wherein the optimal prompt is a prompt that minimizes a marginal entropy function defined based on the prediction probability.

11. The prompt tuning method of claim 7, further comprising:
obtaining a second token used as a ground-truth embedding by performing tokenization on a prompt including a name of a class corresponding to the image.

12. The prompt tuning method of claim 7,
wherein obtaining the class-agnostic attribute based on the at least one class comprising:
obtaining the at least one class;
obtaining a query for the at least one class by using a prompt template;
generating a response corresponding to the query based on at least one language model; and
obtaining the class-agnostic attribute from the response.
